(19) United States
(12) Patent Application Publication
(10) Pub. No.: US 2026/0164174 A1
(43) Pub. Date: Jun. 11, 2026

(54) ULTRASOUND ASSISTED SPATIAL AUDIO

(71) Applicant: Advanced Micro Devices, Inc., Santa Clara, CA (US)

(72) Inventors: Vasuki Soni, Korba (IN); A Srinivas, Hyderabad (IN)

(73) Assignee: Advanced Micro Devices, Inc., Santa Clara, CA (US)

(21) Appl. No.: 18/977,659

(22) Filed: Dec. 11, 2024

(51) Int. Cl. H04R 1/40; G01S 15/04; G01S 15/06

(52) U.S. Cl. CPC H04R 1/403; G01S 15/04; G01S 15/06; H04R 1/406; H04R 2201/405

(57) ABSTRACT

Using ultrasound to assist in spatial audio processing includes emitting audible sound and ultrasound signals from a plurality of speakers of an electronic device. Reflected ultrasound signals are detected by a plurality of microphones of the electronic device. Presence of a user for the electronic device is detected by a hardware processor of the electronic device based on the reflected ultrasound signals. In response to detecting the presence of the user, the hardware processor is capable of adjusting audio played through one or more of the plurality of speakers as audible sound.

### TECHNICAL FIELD

This disclosure relates to spatial audio and, more particularly, to ultrasound assisted spatial audio.

### BACKGROUND

Immersive audio is a sound technology that attempts to place a user inside of a particular sound environment. Multiple channels of audio and speakers are located around the user so that different sound elements of the sound environment may be played by different channels/speakers. The user perceives sounds of the sound environment coming from all around the user.

Spatial audio is a sound technology that attempts to create a 3-dimensional sound environment. Spatial audio simulates sounds emanating from different directions and/or distances in the 3-dimensional sound environment. Whereas immersive audio typically utilizes more than two channels and speakers, spatial audio is often implemented with using headsets, headphones, earphones, earbuds, or the like. In some cases, smart televisions, soundbars, and other multi-speaker systems are capable of providing a spatial audio experience.

Immersive audio does not change or react to motion of the user. The audio played through the various channels and speakers of an immersive audio system does not change in response to user movement. By comparison, spatial audio is dynamic in that the audio may be modified based on movement of the user relative to the sound source and, more particularly, based on head orientation of the user. With spatial audio systems, head-tracking sensors such as accelerometers, inertial-measurement units (IMUs), and the like are used to track motion of the user.

### SUMMARY

In one or more implementations, a method includes emitting audible sound and ultrasound signals from a plurality of speakers of an electronic device. The method includes detecting reflected ultrasound signals by a plurality of microphones of the electronic device. The method includes detecting, by a hardware processor of the electronic device and based on the reflected ultrasound signals, presence of a user for the electronic device. The method includes, in response to the detecting the presence of the user, adjusting, by the hardware processor, audio played through one or more of the plurality of speakers as audible sound.

In one or more implementations, a system includes a hardware processor and a plurality of speakers coupled to the hardware processor. The speakers are capable of emitting audible sound and ultrasound signals under control of the hardware processor. The system includes a plurality of microphones coupled to the hardware processor. The microphones are capable of detecting reflected ultrasound signals. The hardware processor is capable of performing operations including detecting, based on the reflected ultrasound signals, presence of a user for the system. The operations also include, in response to the detecting the presence of the user, adjusting audio played through one or more of the plurality of speakers as audible sound.

In one or more implementations, a computer program product includes a computer readable storage medium having program instructions embodied therewith. The program instructions are executable by computer hardware, e.g., a hardware processor, to cause the computer hardware to execute operations including emitting audible sound and ultrasound signals from a plurality of speakers of an electronic device. The operations include detecting reflected ultrasound signals by a plurality of microphones of the electronic device. The operations include detecting, based on the reflected ultrasound signals, presence of a user for the electronic device. The operations include, in response to the detecting the presence of the user, adjusting audio played through one or more of the plurality of speakers as audible sound.

This Summary section is provided merely to introduce certain concepts and not to identify any key or essential features of the claimed subject matter. Many other features and implementations of the disclosed technology will be apparent from the accompanying drawings and from the following detailed description.

### BRIEF DESCRIPTION OF THE DRAWINGS

The accompanying drawings show one or more implementations of the disclosed technology. The drawings, however, should not be construed to be limiting of the disclosed technology to only the implementations shown. Various aspects and advantages will become apparent upon review of the following detailed description and upon reference to the drawings.

FIGS. 1A, 1B, and 1C illustrate different examples of an electronic device capable of dynamically adapting audio based on user presence using ultrasound signals in accordance with one or more implementations of the disclosed technology.

FIG. 2 illustrates a hardware architecture that may be used to implement the electronic device of FIG. 1 in accordance with one or more implementations of the disclosed technology.

FIG. 3 illustrates a method of providing spatial audio using ultrasound signals in accordance with one or more implementations of the disclosed technology.

FIGS. 4A, 4B, and 4C illustrate audio adjustments for spatial audio implemented by the electronic device of FIGS. 1 and 2 based on user presence and position in accordance with one or more implementations of the disclosed technology.

FIG. 5 illustrates audio adjustments implemented by the electronic device of FIGS. 1 and 2 to implement spatial audio based on user presence and position in accordance with one or more implementations of the disclosed technology.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to spatial audio and, more particularly, to ultrasound assisted spatial audio. In accordance with the implementations described within this disclosure, spatial audio is implemented within an electronic device that uses ultrasound technology to detect presence of a user of the electronic device. The electronic device is a non-wearable, sound generation device that includes a plurality of different channels that deliver audio to a plurality of different speakers for playing as audible sound. For example, the speakers may be fixed in a housing or case of the electronic device.

In accordance with the inventive implementations described within this disclosure, audio that is played by the electronic device may be adjusted to implement spatial audio in response to detected presence of the user. The electronic device is capable of emitting ultrasound signals and detecting presence of the user relative to the electronic device based on reflected ultrasound signals. In one or more examples, a position of the user also is detected based on the reflected ultrasound signals.

Based on the detected presence and/or position of the user, audio conveyed over one or more of the plurality of channels is adjusted for playing through one or more of the plurality of speakers. The disclosed technology may be used with certain types of electronic devices that are capable of generating audio that otherwise do not adapt audio as played based on user position relative to the electronic device.

Further aspects of the disclosed technology are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

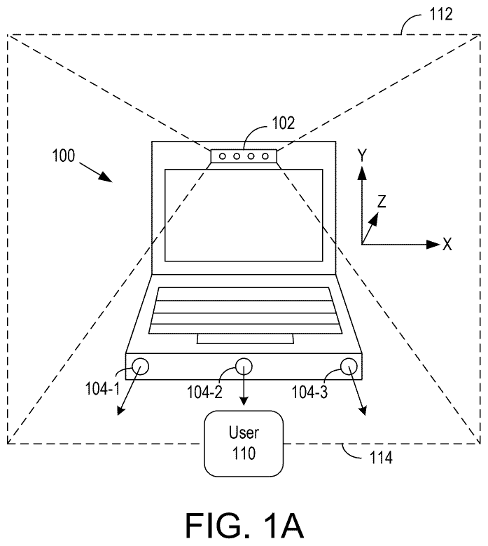

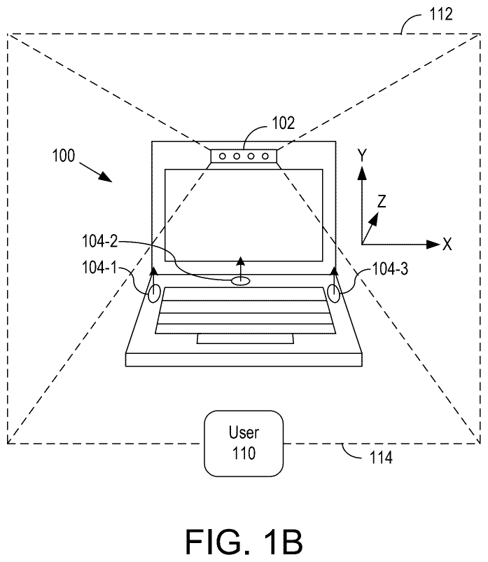

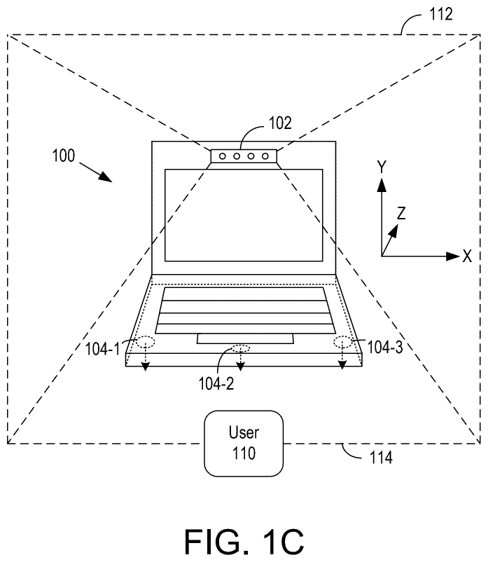

FIGS. 1A, 1B, and 1C illustrate different examples of an electronic device 100 capable of dynamically adapting audio based on user presence using ultrasound signals. For purposes of discussion, FIGS. 1A, 1B, and 1C are collectively referred to as FIG. 1. In the examples of FIG. 1, electronic device 100 includes microphones 102 and speakers 104. Microphones 102 may include two or more microphones. In the example, microphones 102 include four microphones though the particular number of microphones illustrated is not intended to be limiting of the implementations described herein. In one or more examples, microphones 102 may be implemented as one or more microphone arrays where each microphone array includes a plurality of microphones.

In the examples of FIG. 1, speakers 104 may include three speakers (e.g., speaker 104-1, speaker 104-2, and speaker 104-3). In the example, each speaker 104 may be provided audio for playing as audible sound by a channel. In one or more examples, each speaker may correspond to a channel on a one-to-one basis. In one or more other examples, a channel may be coupled to more than one speaker. In the examples of FIG. 1, speakers 104-1, 104-2, and 104-3 may correspond to a left channel, a middle channel, and a right channel, respectively. In one or more examples, electronic device 100 may include N channels where N is an integer value of two or more. As noted, the number of speakers may correspond to the number of channels for conveying audio. In one or more examples, for example, electronic device 100 may include more than three speakers with electronic device 100 having one or more additional speakers positioned in different locations such as on each side.

In the examples of FIG. 1, both microphones 102 and speakers 104 are fixedly positioned in, or as part of, electronic device 100. For example, microphones 102 and speakers 104 may be mounted or secured to a chassis, a case, and/or a housing of electronic device 100. Both microphones 102 and speakers 104 may be ultrasound enabled. More particularly, microphones 102 are capable of detecting sound in the audible range and detecting ultrasound signals. Speakers 104 are capable of generating sound in the audible range as well as generating ultrasound signals. Within this disclosure, the term “sound” refers to sound in the audible range of a human being. The term “ultrasound refers” to sound that is outside of the audible range of a human being. Similarly, the term “audio” refers to audio data, whether analog or digital, in the audible range of a human being.

In one or more examples, speakers 104 may be implemented as ultrasonic, directional, or parametric speakers. In general, ultrasonic speakers are capable of producing more directional sound than conventional speakers because of the shorter wavelength of ultrasonic waves. This allows the sound to be focused on a specific area without increasing ambient noise.

In one or more examples, sound in the audible range includes sounds in the frequency range of approximately 20 Hz to 20 kHz. In one or more examples, ultrasound signals include sound signals (e.g., waves) above the range of human hearing which includes sound waves above 20 KHz. In some cases, as many humans are unable to hear sound waves above frequencies of approximately 16 kHz or 18 kHz, ultrasound signals may be considered to start as low as 16 kHz. In one or more other examples, the ultrasound signals may be defined as the range of approximately 16 KHz to 32 kHz. In one or more other examples, the lower end of the range of ultrasound signals may be 16 kHz, 17 kHz, 18 kHz, 19 kHz, or 20 kHz. In one or more examples, the upper range of the ultrasound signals for purposes of this disclosure may be limited to 30 kHz, 31 kHz, or 32 kHz, for example. Appreciably, other frequencies between the listed upper and lower bounds also may be selected. In still one or more other examples, ultrasound signals may include frequencies as high as approximately 10 MHz. In general, however, typical speakers that are ultrasound emitting enabled are capable of emitting ultrasound signals up to only approximately 200 KHz.

In one or more examples, electronic device 100 may include one or more microphones dedicated to detecting sound (e.g., in the audible range) and a plurality of microphones capable of detecting ultrasound signals. Similarly, electronic device 100 may include a plurality of speakers dedicated to generating sound and one or more speakers capable of generating ultrasound signals. In still other examples, electronic device 100 may include one or more microphones dedicated to detecting sound in the audible range, a plurality of microphones capable of detecting ultrasound signals, a plurality of speakers dedicated to generating sound in the audible range, and one or more speakers capable of generating ultrasound signals. The particular configuration of microphones and speakers is not intended as a limitation of the examples described so long as electronic device 100 is capable of generating sound, generating ultrasound signals, and detecting reflected ultrasound signals.

In one or more examples, microphones 102 may be arranged along a particular axis that may coincide, or be the same as, the axis along which speakers 104 are arranged. In the example of FIG. 1A, microphones 102 are aligned on a line that is parallel to the X-axis. Microphones 102 may also be said to be in a plane defined by the X-Y axes. Similarly, speakers 104 are aligned on a line that is also parallel to the X-axis. In the example of FIG. 1A, speakers 104 may be said to be in a plane defined by the X-Y axes such that sound is projected out from a front of electronic device 100 (e.g., in the −Z direction). The position of user 110 may be determined at least with respect to a location or position along a line that is parallel to the X-axis (e.g., line 114) within observation region 112.

In the example of FIG. 1B, speakers 104 may be said to be in a plane defined by the X-Z axes such that sound is projected upward out from a top surface (e.g., a keyboard) of electronic device 100 (e.g., in the Y direction). In this arrangement, the position of user 110 may be determined at least with respect to a location or position along a line that is parallel to the X-axis (e.g., line 114) within observation region 112.

In the example of FIG. 1C, speakers 104 may be said to be in a plane defined by the X-Z axes such that sound is projected downward out from a bottom surface of electronic device 100 (e.g., in the −Y direction). In this arrangement, the position of user 110 may be determined at least with respect to a location or position along a line that is parallel to the X-axis (e.g., line 114) within observation region 112.

In general, microphones 102 are often positioned with or near an embedded camera of the electronic device. It should be appreciated that the examples illustrated in FIGS. 1A, 1B, and 1C with respect to geometry of microphones 102 and speakers 104, where geometry may define a position and an orientation of microphones 102 and speakers 104, are provided for purposes of illustration and are not intended to be limiting of the examples described herein. Microphones 102 may be positioned differently with respect to electronic device 100 and/or in different orientations. Similarly, speakers 104 may be positioned differently with respect to electronic device 100 and/or in different orientations.

Continuing with FIG. 1 in general, as ultrasound signals are used to detect user presence, if user presence is detected, the user is assumed to be within a predetermined distance of electronic device 100. In one or more examples, the predetermined distance may be approximately 0.5 meters. The predetermined distance may be set based on the type of electronic device 100. For example, in the case of a portable computer such as a laptop computer, the user is typically positioned no more than approximately 0.5 meters from the device. Appreciably, the predetermined distance, which is illustrated in FIG. 1 as line 114, may differ for other types of devices within the physical constraints of emitting ultrasound signals and detecting reflected ultrasound signals.

In operation, speakers 104 are capable of emitting ultrasound signals into a particular region referred to as observation region 112 (e.g., the entire volume defined by the dashed lines emanating from microphones 102). Observation region 112 may be defined by the angle of incidence of ultrasound signals that are detectable by microphones 102. Observation region 112 also may be bounded by the predetermined distance corresponding to line 114 (e.g., the plane including line 114 defined by the X-Y axes). Microphones 102 are capable of detecting ultrasound signals that are reflected back to electronic device 100. The reflected signals detected by microphones 102 that reflect off user 110 located within observation region 112 will differ from those reflected off of hard surfaces and the ultrasound signals emitted by speakers 104. Within this disclosure, the ultrasound signals emitted by speakers 104 are also referred to as “original ultrasound signals.” The difference between the original and reflected ultrasound signals arises, at least in part, due to absorption of ultrasound signals by the body of user 110. Based on the differing ultrasound signals detected, electronic device 100 may detect a position of user 110. Based on the position of user 110 as detected, electronic device 100 may adjust the audio that is played via speakers 104.

In one or more examples, the position detection performed by electronic device 100 is capable of detection a position of user 110 along the X-axis, e.g., along line 114. In one or more examples, the position detection may detect the position of the user along any axis for which microphones are distributed to detect ultrasound signals. Electronic device 100 is capable of dynamically adjusting the audio played via speakers 104 over time based on detected ultrasound signals. In one or more examples, electronic device 100 is capable of adjusting audio played via speakers 104 in real-time based on detected presence of user 110 and/or location of user 110.

In the example of FIG. 1, electronic device 100 is embodied as a portable computing device such as a laptop computer. In one or more other examples, electronic device 100 may be embodied as a computer monitor, a television, or other sound generating appliance. In general, electronic device 100 is illustrative of a device having sound generating capabilities that, without inclusion of the various examples of the disclosed technology, is unable to implement spatial audio using the non-wearable audio/speaker system of the device itself. This excludes cases where the electronic device becomes coupled, via a wired and/or wireless connection, to wearable sound generating devices such as, for example, headsets, headphones, earphones, earbuds, or the like.

As an illustrative example, a conventional laptop computer is unable to provide spatial audio using only the built-in or internal speakers based on user position relative to the laptop computer and/or the built-in speakers of the laptop computer. In a conventional laptop computer, if the position and/or orientation of the user changes relative to the device and/or speakers of the device even with spatial audio enabled, the audio played by the device does not change in response to presence, position, or changing position of the user. The laptop computer may be said to be agnostic with respect to user position.

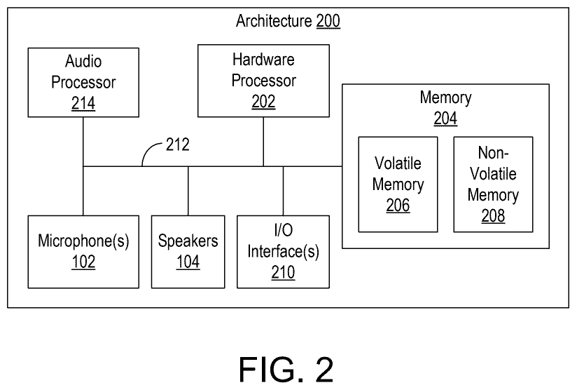

FIG. 2 illustrates a hardware architecture that may be used to implement electronic device 100 in accordance with one or more implementations of the disclosed technology. Architecture 200 may be used to implement a data processing system. A “data processing system” refers to one or more hardware systems capable of processing data. Each hardware system may include one or more hardware processors and memory.

Architecture 200 includes a hardware processor 202. Hardware processor 202 may be implemented as one or more hardware processors. Hardware processor 202 may be implemented as one or more circuits capable of executing computer-readable program instructions (program instructions). The circuit(s) may comprise integrated circuits (ICs) or may be embedded within an IC. In one or more examples, hardware processor 202 may be embodied as a central processing unit (CPU). Hardware processor 202 may include one or more cores, for example, where each core is capable of executing program instructions. Hardware processor 202 may be implemented using any of a variety of architectures such as, for example, a complex instruction set computer architecture (CISC), a reduced instruction set computer architecture (RISC), a vector processing architecture, or other known architectures. For example, a hardware processor may be implemented using an x86 architecture (e.g., IA-32, IA-64), a Power Architecture, as an ARM processor, or the like.

Architecture 200 can include memory 204. Memory 204 may be embodied as one or more computer-readable storage mediums. Memory 204 may include a volatile memory 206 and a non-volatile memory 208. Volatile memory 206 may be embodied as random-access memory (RAM) and may include cache memory. Volatile memory 206 may be referred to as “runtime memory.” Non-volatile memory 208 may include a non-volatile magnetic medium and/or a solid-state medium (typically called a “hard drive”). Non-volatile memory 208 also may include one or more disk drives capable of reading from and writing to various types of removable, non-volatile mediums such as a removable, non-volatile magnetic disk (e.g., a “floppy disk”) and/or a removable, non-volatile optical disk such as a CD-ROM, DVD-ROM or other optical media.

Memory 204 is capable of storing program instructions and/or data such that hardware processor 202 is capable of executing the program instructions to perform one or more operations as described within this disclosure. For example, the program instructions can include an operating system, one or more application programs, other program code such as an audio driver, and program data. Hardware processor 202, in executing the computer-readable program instructions, is capable of performing the various operations described herein that are attributable to a computer.

In one or more examples, architecture 200 includes an audio processor 214. Audio processor 214 may be implemented as a hardware processor as described herein in connection with hardware processor 202. Audio processor 214 is capable of, or dedicated to, processing audio. For example, audio processor 214 may be implemented as a digital signal processor (DSP) or an audio codec. In one or more examples, one or more or all of the operations described herein may be performed by hardware processor 202. In one or more examples, one or more or all of the operations described herein may be offloaded from hardware processor 202 and performed by audio processor 214. Though called an “audio processor,” audio processor 214 is capable of processing both audio and ultrasound signals.

Architecture 200 may include one or more Input/Output (I/O) interfaces 210. I/O interface(s) 210 allow architecture 200 to communicate with one or more external devices and/or communicate over one or more networks such as a local area network (LAN), a wide area network (WAN), and/or a public network (e.g., the Internet). Examples of I/O interfaces 210 may include, but are not limited to, network cards, modems, network adapters (whether wired and/or wireless), hardware controllers, etc. Examples of external devices also may include devices that allow a user to interact with architecture 200 (e.g., a display, a keyboard, and/or a pointing device) and/or other devices such as accelerator card.

Bus 212 represents one or more of any of a variety of communication bus structures. By way of example, and not limitation, bus 212 may be implemented as a Peripheral Component Interconnect Express (PCIe) bus. Bus 212 is capable of coupling to each of microphones 102, speakers 104, hardware processor 202, memory 204, I/O interface(s) 210, and audio processor 214 (if included). The respective devices coupled to bus 212 may be coupled through respective interface circuitry. Bus 212 may represent a plurality of buses that may be interconnected and/or hierarchically organized.

In one or more other examples, microphones 102 and speakers 104 may be coupled to bus 212 and/or other components illustrated in FIG. 2 directly by way of interface circuitry. For example, interface circuitry for microphones 102 may include analog-to-digital (A/D) conversion circuitry and a bus interface. Interface circuitry for speakers 104 may include a bus interface, digital-to-analog (D/A) conversion circuitry, and amplifier circuitry to drive speakers 104. Further, such interface circuitry may support multiple channels to drive each of speakers 104 on an individual speaker-by-speaker basis. Similarly, the interface circuitry for microphones 102 may support each microphone or microphone array as the case may be such that the results from each different microphone or microphone array may be provided to the relevant processor.

It should be appreciated that the interface circuitry may support A/D and D/A sampling rates sufficient to process audio and ultrasound in observance of the Nyquist rate. For example, if ultrasound signals of 20-22 kHz are used, the sampling rate used must be at least 44 kHz to support detection of ultrasound signals of 22 kHz. Accordingly, the particular frequencies of ultrasound signals used with the examples described herein must be supported by the sampling rate available in the hardware.

As discussed, the particular starting point for what is considered to be an ultrasound signal may depend on the particular implementation of electronic device 100. That is, digital filtering, e.g., a high pass filter, may be defined and implemented by hardware processor 202 or audio processor 214 to separate audio from ultrasound signals for purposes of detecting reflected ultrasound signals. The particular cut off frequency of the high pass filter may be selected as a frequency outside of the audible range.

Architecture 200 is only one example implementation and is not intended to suggest any limitation as to the scope of use or functionality of example implementations described herein. Architecture 200 is an example of computer hardware that is capable of performing the various operations described within this disclosure. In this regard, architecture 200 may include fewer components than shown or additional components not illustrated in FIG. 2 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

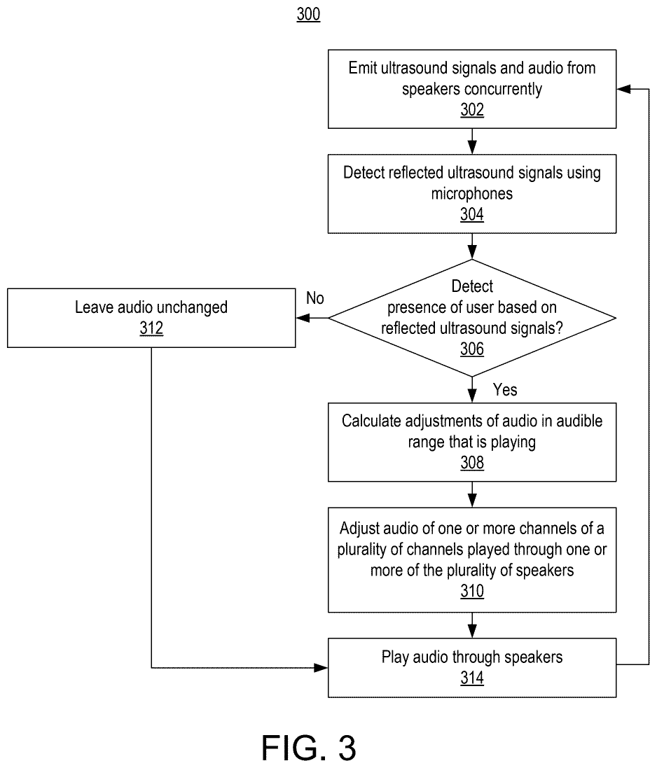

FIG. 3 illustrates a method 300 of providing spatial audio using ultrasound signals in accordance with one or more implementations of the disclosed technology. Method 300 may be performed by electronic device 100 using an architecture the same as or similar to that described in connection with FIG. 2.

Method 300 may be performed in the context of electronic device 100 playing audio through speakers 104. Accordingly, method 300 may be implemented concurrently with the playing of audio so as to provide a mechanism for dynamically adjusting the audio played, e.g., performing spatial audio, based on user presence and/or position. Within the example of FIG. 3, for purposes of illustration, electronic device 100 is described as including two channels corresponding to a left channel and a right channel. It should be appreciated that the examples may be implemented for N different channels, where N is an integer value of two or more.

In block 302, electronic device 100 is capable of emitting ultrasound signals from speakers 104. More particularly, speakers 104 may play sound in the audible range concurrently with emitting ultrasound signals and do so under control of hardware processor 202 and/or audio processor 214. The particular frequency or frequencies of ultrasound signals emitted may be selected such that the hardware of electronic device 100 is capable of sampling those frequencies in terms of the Nyquist rate. The ultrasound signals may be streamed from all channels of speakers. For purposes of discussion and illustration, electronic device 100 is presumed to include one speaker for each of the N channels. As noted, in other examples, this relationship may differ. Accordingly, in the example of FIG. 3, ultrasound signals may be emitted from both the left channel and the right channel concurrently with audio.

In block 304, electronic device 100 is capable of detecting reflected ultrasound signals using microphones 102. As discussed, the output from microphones 102 may be sampled at or above the Nyquist rate for the selected frequency or frequencies of ultrasound signals. For the remainder of FIG. 3, the term “processor” is intended to refer to hardware processor 202, audio processor 214, or both hardware processor 202 and audio processor 214 working cooperatively. In block 304, for example, the processor is capable of applying a digital filter such as a high bandpass filter so as to extract or separate the ultrasound signals from the audio to facilitate detection of reflected ultrasound signals and the processing thereof.

In block 306, electronic device 100 is capable of detecting the presence of a user based on the reflected ultrasound signals. For example, in block 306, the processor is capable of comparing the original ultrasound signals with the reflected ultrasound signals detected by microphones 102. In response to detecting that a user is present, method 300 continues to block 308. In response to detecting that no human is present, method 300 continues to block 312.

In one or more examples, the comparing may be implemented using a cross-correlation technique. The cross-correlation may be calculated with respect to, or using, a predetermined window of time referred to as the “observation window.” The observation window is applied to detect signals within the observation regions as previously discussed. The observation window may be defined as the time necessary for an ultrasound signal, as emitted from speakers 104, to be reflected by a user human body located at no more than the predetermined distance from electronic device 100 (e.g., line 114 which may be approximately 0.5 meters in some example implementations) to be received by microphones 102. As discussed, the particular predetermined distance may vary with the type of electronic device 100, geometry of speakers and microphones, and the ability of electronic device 100 to emit ultrasound signals and detect reflected ultrasound signals.

For example, electronic device 100 is capable of detecting presence of a user within the observation region of electronic device 100. When a user is present within the observation region, the ultrasound signals are at least partially absorbed and/or attenuated by the user. The absorption means that ultrasound signals are reflected back toward microphones 102 with a reduced or lesser intensity compared to as transmitted. Further, the reflected ultrasound signals are reflected back toward microphones 102 at different angles. This means that in cases where the user is present, e.g., user presence is detected, reflected ultrasound signals have a lower cross-correlation value compared to the original ultrasound signals due to partial absorption by a human body.

In cases where the user is not present, e.g., presence is not detected, the reflected ultrasound signals will have a higher cross-correlation value with the original ultrasound signals. A higher cross-correlation value indicates that original ultrasound signals have not been deformed by partial absorption by a human body. The detected ultrasound signals will have a higher cross-correlation value due to the ultrasound signals reflecting off of non-absorbing surfaces such as walls and/or other objects in the sound environment. In this case, the reflected ultrasound signals typically have similar intensities as the original ultrasound signals.

Another indication that the reflected ultrasound signals were not reflected off of a user is that reflected ultrasound signals will take longer to be detected by microphones 102 because the ultrasound signals will typically travel farther and/or reflect off of multiple different surfaces before returning to microphones 102. That is, without the user being present within the predetermined distance from, or within the observation region of, electronic device 100, ultrasound signals will continue to propagate beyond that predetermined distance before reflecting back to microphones 102. This means that the reflected signals are received outside of the observation window previously described.

In cases where the user is not within the predetermined distance of electronic device 100, the ultrasound signals still may be at least partially absorbed by the user. In this scenario, those reflected ultrasound signals that are at least partially absorbed by the user are received outside of the observation window. Accordingly, in this scenario, electronic device 100 interprets this as the user not being present.

In one or more examples, the observation window may be defined by a buffer size used to collect sampled data from each of microphones 102. That is, the amount of time or length of time of the observation window is defined by the size of the buffer given a known sampling rate. The buffer size for each microphone 102 used to store sampled, reflected ultrasound signals may be a configurable parameter that may be increased or decreased based on the expected predetermined distance of the user and/or the particular geometry of microphones 102 and speakers 104. For example, longer predetermined distances may require longer observation windows and, as such, larger buffers. Different geometries of microphones 102 and speakers 104 also may require different buffer sizes.

The processor of electronic device 100 may perform cross-correlation as described using one or more different signal processing techniques. The signal processing technique used to perform cross-correlation is used by the processor to calculate a plurality of cross-correlation values.

In one or more examples, the processor implements a classic correlation technique that compares the original ultrasound signals with the reflected ultrasound signals. For purposes of illustration, consider the case in which

$${x}_{ref}^{k}$$

is the k^{th} frame of microphone data received representing reflected ultrasound signals and

$${x}_{j}^{k}$$

is the k^{th} frame of the original ultrasound signal on speakers 104. The cross-correlation of the k^{th} frame of

$${x}_{ref}^{k} and the {x}_{j}^{k}$$

frame is denoted as

$$c o r {r}_{j}^{k}$$

and is defined by Expression 1 below.

$${corr}_{j}^{k} ( n ) = {\sum }_{p = 0}^{2 * sz - 1} {x}_{ref}^{k} ( p + n ) * {x}_{j}^{k} ( n ) \{ ( n > 0 ) , ( ∀ j \neq i ) ) \qquad ( 1 )$$

In Expression 1, sz is the size of the observation window, n is the sample, and p is the time lag or shift between the two signals being compared. The correlation function

$$c o r {r}_{j}^{k}$$

depicts the similarity of

$${x}_{r e f}^{k}$$

compared to the time-shifted signal

$${x}_{j}^{k} .$$

The higher the value of the cross-correlation, the more similar both signals are to each other. The operation illustrated in Expression 1 may be performed for each of the different microphones 102 resulting in a cross-correlation value for each microphone for each frame of ultrasound played via speakers 104. In one or more examples, a frame refers to a plurality of samples.

In one or more other examples, the cross-correlation values are generated using a Long Short-Term Memory (LSTM) based machine learning model. The LSTM model may be pre-trained using ultrasound signals to classify whether a particular microphone has detected presence of the user within the observation window. The LSTM model is suited to operate on sequential data that has longer term dependencies such as the original ultrasound signals and the reflected ultrasound signals over the observation window. The LSTM model is well-suited to memorize past ultrasound signal data and perform classification on the complete data corresponding to the observation window to make a classification decision (e.g., user present or not present for any particular microphone). The LSTM model may output a numeric value that, for purposes of discussion herein, is also referred to as a cross-correlation value. As was the case for the classic correlation technique, the LSTM model may be used to generate a cross-correlation value for each microphone for each frame of ultrasound played via speakers 104.

Accordingly, in one or more examples, electronic device 100 is capable of detecting presence of a user by calculating cross-correlation of the original ultrasound signals and the reflected ultrasound signals. The processor of electronic device 100 may use a predetermined threshold cross-correlation value (the “predetermined threshold”) to compare the cross-correlation result. A lesser cross-correlation value indicates that a user is present while a higher cross-correlation value indicates that the user is not present. Accordingly, in one or more examples, electronic device 100 compares the cross-correlation value with the predetermined threshold. A cross-correlation value greater than or equal to the predetermined threshold indicates that no user is present. A cross-correlation value less than the predetermined threshold indicates that the user is present.

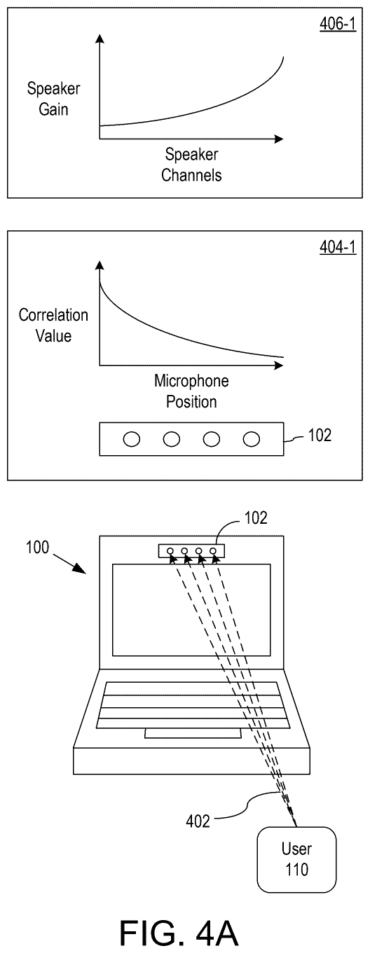

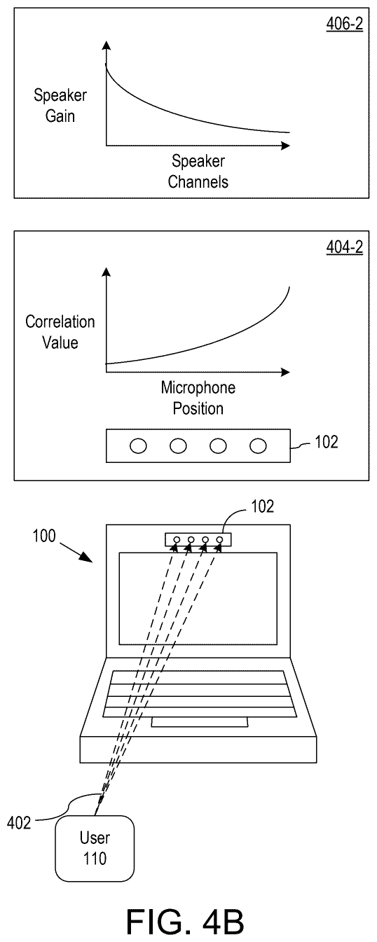

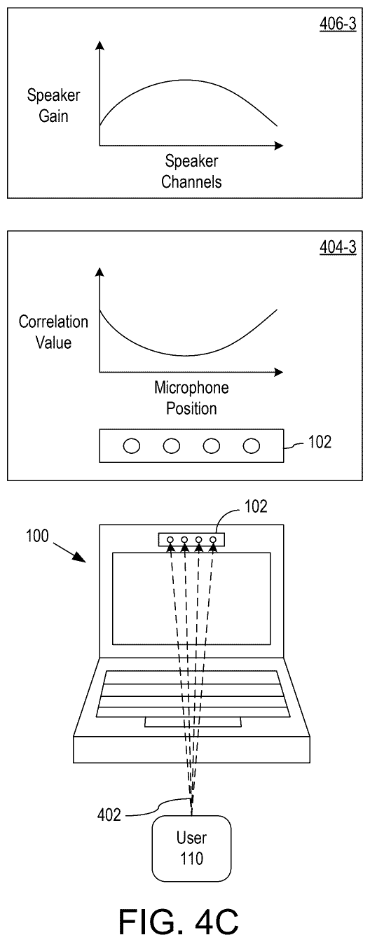

By using a plurality of microphones 102 such as one or more microphone arrays, not only may presence of a user be detected as described, but a position of the user may also be detected. In general, the user is considered to be present or near the particular microphones 102 that detect reflected ultrasound signals with the highest correlation. The user is considered not to be present or near microphones that detect reflected ultrasound signals having lower cross-correlation. Detecting a position of the user is described and illustrated herein in greater detail in connection with FIGS. 4A, 4B, and 4C.

Continuing with block 312 in the case where no user presence is detected, the audio played by electronic device 100 is left unchanged. That is, because no user was detected within a predetermined distance of, or within the observation region for, electronic device 100, audio being played by electronic device 100 may be played or continue to play in its original form unaltered as there is no user present based on which electronic device 100 may dynamically adapt the audio being played.

Continuing with block 308 in the case where user presence is detected, the processor is capable of calculating the particular manner in which the audio in the audible playing through speakers 104 will be adjusted. In block 308, for example, the processor is capable of generating correlation distribution coefficients and channel function(s). Block 308 is performed based on the comparison of the original ultrasound signals with the reflected ultrasound signals as detected by microphones 102.

In one or more examples, the processor is capable of calculating the distribution coefficients using the cross-correlation values. The distribution coefficients may be generated for each speaker channel and may be generated for each frame of audio data that is to be played. For example, electronic device 100 is capable of generating the plurality of coefficients based on Expression 2 below.

$${dist}^{k} ( n ) = f ( c o r {r}_{j}^{k} ( n ) ) \{ ( n > 0 \& n \leq N ) , ( ∀ j ) ) \qquad ( 2 )$$

In one or more examples, the processor is capable of generating the distribution coefficients dist^{k}(n) by normalizing the cross-correlation values (e.g., whether obtained via classic correlation or via the LSTM model). Thus,

$$f ( c o r {r}_{j}^{k} ( n ) )$$

may be a normalization function applied to the cross-correlation values. Using Expression 2, the processor is capable of generating an array of cross-correlation value (e.g., normalized cross-correlation values) for each microphone. In one or more examples, the distribution coefficients may be calculated for each of a plurality of different speaker channel to microphone mappings.

In one or more examples, the cross-correlation techniques described herein may be used to calculate the correlation between each microphone and each speaker of electronic device 100. For example, in a simplified system including left and right microphones and left and right speakers, a correlation between each pairing of left microphone and left speaker; left microphone and right speaker; right microphone and left speaker; and right microphone and right speaker may be calculated. If the user is present in the direction of the left microphone and the left speaker, the cross-correlation is low due to absorption. In such cases, different cross-correlation values as normalized may be combined (e.g., summed or weighted and summed) depending on the particular speaker configuration (e.g., number of speakers, microphone to speaker mapping, and speaker orientations) where each different cross-correlation result may be mapped to a particular speaker/channel and weighted accordingly to obtain a final cross-correlation result as normalized to be used for the speaker/channel in calculating the gain mask for that speaker/channel.

As part of block 308, the processor is capable of generating gain masks from the distribution coefficients. In one or more examples, the processor is capable of generating the gain masks by inverting the respective distribution coefficients. For example, referring to the normalized distribution coefficients, the processor may generate the gain masks according to the expression (1−distribution_coefficient).

The processor is capable of applying the gain masks generated to the audio being played by the device to ensure that the audio being rendered through speakers 104 is steered toward the particular speaker deemed closest to user. By steering audio toward the speaker closest to the user (e.g., steering audio to speakers based on distance of the speaker to the user's position), and continuing to do so dynamically over time as the user moves and audio is played, the user is provided with a more consistent audio experience as the user moves about electronic device 100 or at least in the observation region. Appreciably, the steering may steer audio to one or more speakers based on distance of the speaker to the user. The user is better able to hear audio content from the different channels as each channel is adjusted by steering the audio toward the user.

In block 310, in response to the detecting the presence of the user and/or position of the user, the processor of electronic device 100 is capable of adjusting audio played through one or more of the plurality of speakers as audible sound. For example, the processor is capable adjusting audio of one or more channels of a plurality of channels played through respective ones of speakers 104. The adjusting, as performed by the processor, may include steering audio of one or more audio channels to at least one speaker of the plurality of speakers based on a distance of the at least one speaker and the position of the user.

For purposes of illustration, consider the case where the number of channels (of audio) that electronic device 100 may play are correlated with the speakers on a one-to-one basis. Consider an example in which the user is positioned in front of speaker 104-3. In that case, the gain masks may cause the left speaker to play the audio of the left channel at a reduced volume while diverting at least a portion of the audio of the left channel to the right channel to be played through speaker 104-3. The diverted portion of the left channel audio may be summed with the right channel audio and played through speaker 104-3. The gain masks effectively create a map of the reflected ultrasound signals detected by microphones 102 to speakers 104.

In block 314, electronic device 100 is capable of playing audio through speakers 104. In arriving at block 314 from block 312, the audio is played without modification or adjustment. In arriving at block 314 from block 310, the audio is played as adjusted in block 310.

In the case where audio being played is adjusted, the gain masks may be provided to an audio driver, plug-in, or other software component that may be executed by hardware processor 202 or audio processor 214 that controls rendering of audio to the different channels and, as such, to the different speakers 104. As noted, audio may be steered toward the user based on presence and position of the user. As an example, if the audio stream rendered by an application is represented as x(n) and y(n) represents the audio stream after adjustment based on user presence and position, then y(n) may be generated according to Expression 3.

$${y}^{k} ( n ) = f ( {dist}^{k} ( n ) , {x}^{k} ( n ) ) \{ ( n > 0 ) , ( ∀ j ) ) \qquad ( 3 )$$

The steering of the audio stream toward the user may be performed linearly to avoid any sudden changes in audio the audio experience. To provide the linear behavior, the distribution function ƒ in Expression 3 above is implemented as a piece-wise linear function for the k^{th} frame. In one or more examples, the distribution function dist^{k}(n) generates a gain mask

$${α}_{j}^{k}$$

for each frame per channel for the rendered audio stream as illustrated in Expression 4 below where k represents the frame, j represents the playback channel, and

$${α}_{j}^{k} ( n )$$

represents the gain mask derived for every k^{th} frame for the j^{th} channel.

$${y}_{j}^{k} ( n ) = {\sum }_{n = 1}^{N} {α}_{j}^{k} ( n ) * {x}_{j}^{k} ( n ) \{ ( n > 0 \& n \leq N ) , ( ∀ j ) ) \qquad ( 4 )$$

For example, in case of N channel audio playback where N=2, Expressions 5 and 6 are illustrative of the audio output from each of the two channels.

$${y}_{1}^{k} ( 1 ) = {α}_{1}^{k} ( 1 ) * {x}_{1}^{k} ( 1 ) + {α}_{1}^{k} ( 2 ) * {x}_{2}^{k} ( 2 ) \qquad ( 5 )$$

$${y}_{2}^{k} ( 2 ) = {α}_{2}^{k} ( 1 ) * {x}_{1}^{k} ( 1 ) + {α}_{2}^{k} ( 2 ) * {x}_{2}^{k} ( 2 ) \qquad ( 6 )$$

In Expressions 5 and 6,

$${x}_{1}^{k} ( 1 ) and {x}_{2}^{k} ( 2 )$$

represent the original audio data for channels 1 and 2 respectively for each frame.

$${y}_{1}^{k} ( 1 ) and {y}_{2}^{k} ( 2 )$$

represent the modified spatial audio data for each frame generated from original audio data using gain mask sets

$$\{ {α}_{1}^{k} ( 1 ) , {α}_{1}^{k} ( 2 ) \} and \{ {α}_{2}^{k} ( 1 ) , {α}_{2}^{k} ( 2 ) \}$$

for channels 1 and 2, respectively. It should be appreciated that the gain masks may be generated based on the ultrasound signal processing described and, as such, may be applied to the audio being rendered in real-time and/or substantially real-time. The examples described herein seek to maintain consistent audio quality across audio channels despite changes in the user position occurring over time.

Method 300 may continue to loop back to block 302 to continually and dynamically adjust audio played by electronic device 100 to provide a spatial audio experience as the user continues to move and/or be present (or not) relative to electronic device 100. The implementations described herein are capable of tracking user position based on presence detection data and, based on that data, adjust audio played from the different speakers by, at least in part, changing the distribution of audio across the different channels based on the user position.

FIGS. 4A, 4B, and 4C illustrate audio adjustments for spatial audio implemented by electronic device 100 based on user presence and position in accordance with one or more examples of the disclosed technology. Within each of FIGS. 4A, 4B, and 4C, speakers 104 are not illustrated as the examples may be applied to any of a variety of speaker numbers and/or geometries.

Appreciably, depending on the speaker numbers and/or geometries, certain parameters such as the observation window and/or the mapping of microphones to particular speakers (audio channels) may vary. The mappings may be one-to-one (one microphone/microphone array to one speaker), one-to-many (one microphone/microphone array to two or more speakers), or a combination thereof. In general, however, the greater the predetermined distance for which the user may be detected, the larger the buffer size (observation window) required. Further, in general, down-firing speakers (e.g., FIG. 1C) will utilize a larger observation window compared to up-firing speakers (e.g., FIG. 1B).

Within each of FIGS. 4A, 4B, and 4C, graph 404 illustrates the correlation values generated using cross-correlation for the microphones 102. Graph 406 illustrates the steering implemented to provide spatial audio based on graph 404.

In the example of FIG. 4A, the user is positioned in front of speaker 104-3 (on the right). As illustrated in graph 404-1, the correlation values calculated based on reflected ultrasound waves 402 from user 110 are lower for the microphones 102 toward the right than those on the left due to absorption. This causes the driver to steer audio toward speaker 104-3 and the user as illustrated by graph 406-1.

In the example of FIG. 4B, the user is positioned in front of speaker 104-1 (on the left). As illustrated in graph 404-2, the correlation values calculated based on reflected ultrasound waves 402 from user 110 are lower for the microphones 102 toward the left than those on the right due to absorption. This causes the driver to steer audio toward speaker 104-1 and the user as illustrated by graph 406-2.

In the example of FIG. 4C, the user is positioned in front of speaker 104-2 (in the center). As illustrated in graph 404-3, the correlation values calculated based on reflected ultrasound waves 402 from user 110 are lower for the microphones 102 on both the left and right edges than in the center due to absorption. This causes the driver to steer audio toward speaker 104-2 and the user as illustrated by graph 406-3.

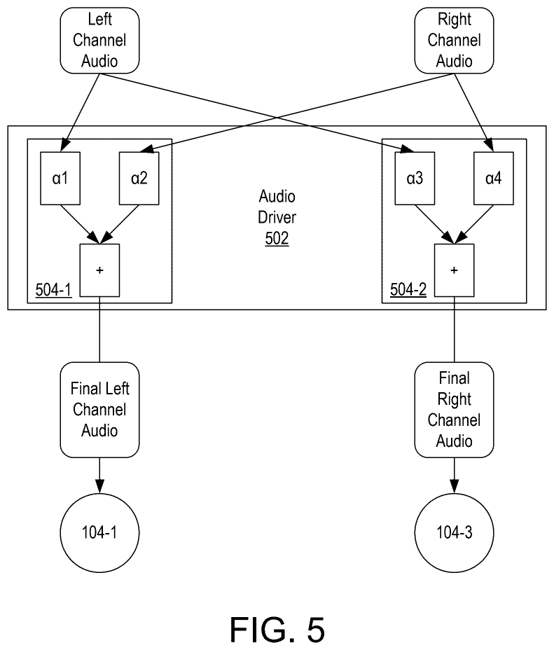

FIG. 5 illustrates a simplified example of audio adjustments performed by electronic device 100 to implement spatial audio based on user presence and position in accordance with one or more examples of the disclosed technology. The example of FIG. 5 illustrates one example of how audio may be adjusted and delivered to different channel speakers 104-1 and 104-3. For purposes of illustration, only two speakers are illustrated in the example of FIG. 5. In the example of FIG. 5, the processor, by way of the gain masks, adjusts an amount of audio corresponding to each channel played through one or more of the plurality of speakers.

An audio driver 502 includes a channel 504 (e.g., a processing pipeline) for each speaker. As illustrated, audio driver 502 includes a channel 504-1 for speaker 104-1 and a channel 504-2 for speaker 104-3. In the example, each channel 504 receives both left channel audio and right channel audio. Channel 504-1 applies a gain mask α1 to the left channel audio and a gain mask α2 to the right channel audio. The results are summed and output as final left channel audio to speaker 104-1. Channel 504-2 applies a gain mask α3 to the left channel audio and a gain mask α4 to the right channel audio. The results are summed and output as final right channel audio to speaker 104-3.

Appreciably, the gain masks α1, α2, α3, and α4 are adjusted dynamically in real time, over time, based on detected presence of the user and, when presence is detected, the detected position of the user in front electronic device 100. FIG. 5 illustrates that the different channels of audio may be dynamically redirected and steered toward the user based on the user's position. In the example of FIG. 5, not only the gain or volume of each channel of audio is being adjusted, but also the particular channel speaker to which the audio is directed may change by adjusting the gain masks as illustrated. That is, the amount of each audio channel carried or played by a particular channel speaker may be adjusted dynamically in real time. This ensures that despite the position of the user in front of electronic device 100, the user receives content from each of the audio channels.

The terminology used herein is for the purpose of describing particular examples only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of a computer-readable storage medium or two or more computer-readable storage mediums. A non-exhaustive list of examples of a computer-readable storage medium may include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a double-data rate synchronous dynamic RAM memory (DDR SDRAM or “DDR”), a portable compact disc read-only memory (CD-ROM), a digital versatile disk (DVD), a memory stick, a floppy disk, or the like.

As defined herein, the phrase “in response to” and the phrase “responsive to” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the term “user” refers to a human being.

As defined herein, the term “hardware processor” means at least one hardware circuit. The hardware circuit may be configured to carry out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a controller, a Graphics Processing Unit (GPU), and an audio processor.

As defined herein, the term “real-time” means a level of processing responsiveness that a user or system senses as sufficiently immediate for a particular process or determination to be made, or that enables the processor to keep up with some external process.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer-readable storage medium (or mediums) having computer-readable program instructions thereon for causing a processor to carry out aspects of the disclosed technology. Within this disclosure, the terms “program code,” “program instructions,” and “computer-readable program instructions” are used interchangeably. Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives program instructions from the network and forwards the computer-readable program instructions for storage in a computer-readable storage medium within the respective computing/processing device.

Program instructions for carrying out operations for the disclosed technology may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Program instructions may include state-setting data. The program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the program instructions by utilizing state information of the program instructions to personalize the electronic circuitry, in order to perform aspects of the disclosed technology.

Certain aspects of the disclosed technology are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by program instructions, e.g., program code.

These program instructions may be provided to a processor of a computer, special-purpose computer, or other programmable data processing apparatus to produce a machine, such that the program instructions, which execute via the processor of the computer or other programmable data processing apparatus, create means for implementing the functions/acts specified in the flowchart and/or block diagram block or blocks. These program instructions may also be stored in a computer-readable storage medium that can direct a computer, a programmable data processing apparatus, and/or other devices to function in a particular manner, such that the computer-readable storage medium having program instructions stored therein comprises an article of manufacture including program instructions which implement aspects of the operations specified in the flowchart and/or block diagram block or blocks.

The program instructions may also be loaded onto a computer, other programmable data processing apparatus, or other device to cause a series of operations to be performed on the computer, other programmable apparatus or other device to produce a computer implemented process, such that the program instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the disclosed technology. In this regard, each block in the flowchart or block diagrams may represent a module, segment, or portion of instructions, which comprises one or more program instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and program instructions.

The descriptions of the various implementations s of the disclosed technology have been presented for purposes of illustration, but are not intended to be exhaustive or limited to the disclosed technology. Many modifications and variations will be apparent to those of ordinary skill in the art without departing from the scope and spirit of the examples described. The terminology used herein was chosen to best explain the principles of the disclosed technology, the practical application or technical improvement over technologies found in the marketplace, or to enable others of ordinary skill in the art to understand the implementations disclosed herein.

What is claimed is:

1. A method, comprising:
emitting audible sound and ultrasound signals from a plurality of speakers of an electronic device;
detecting reflected ultrasound signals by a plurality of microphones of the electronic device;
detecting, by a hardware processor of the electronic device and based on the reflected ultrasound signals, presence of a user for the electronic device; and
in response to the detecting the presence of the user, adjusting, by the hardware processor, audio played through one or more of the plurality of speakers as audible sound.

2. The method of claim 1, wherein the detecting presence comprises:
calculating cross-correlation values between the ultrasound signals and the reflected ultrasound signals.

3. The method of claim 2, wherein the cross-correlation values are calculated for each microphone of the plurality of microphones.

4. The method of claim 2, further comprising:
detecting a position of the user relative to the electronic device based on the cross-correlation values.

5. The method of claim 4, wherein the adjusting comprises steering audio of one or more audio channels to at least one speaker of the plurality of speakers based on the position of the user.

6. The method of claim 2, further comprising:
generating distribution coefficients from the cross-correlation values;
generating gain masks from the distribution coefficients; and
processing the audio of each speaker using the gain masks.

7. The method of claim 6, wherein the gain masks adjust an amount of audio corresponding to each channel played through one or more of the plurality of speakers.

8. A system, comprising:
a hardware processor;
a plurality of speakers coupled to the hardware processor and capable of emitting audible sound and ultrasound signals under control of the hardware processor; and
a plurality of microphones coupled to the hardware processor and capable of detecting reflected ultrasound signals;
wherein the hardware processor is capable of performing operations including:
detecting, based on the reflected ultrasound signals, presence of a user for the system; and
in response to the detecting the presence of the user, adjusting audio played through one or more of the plurality of speakers as audible sound.

9. The system of claim 8, wherein the detecting presence comprises:
calculating cross-correlation values between the ultrasound signals and the reflected ultrasound signals.

10. The system of claim 9, wherein the cross-correlation values are calculated for each microphone of the plurality of microphones.

11. The system of claim 9, wherein the hardware processor is capable of performing operations including:
detecting a position of the user relative to the system based on the cross-correlation values.

12. The system of claim 11, wherein the adjusting comprises steering audio of one or more audio channels to at least one speaker of the plurality of speakers based on the position of the user.

13. The system of claim 9, wherein the hardware processor is capable of performing operations including:
generating distribution coefficients from the cross-correlation values;
generating gain masks from the distribution coefficients; and
processing the audio of each speaker using the gain masks.

14. The system of claim 13, wherein the gain masks adjust an amount of audio corresponding to each channel played through one or more of the plurality of speakers.

15. A computer program product comprising a computer readable storage medium having program instructions embodied therewith, wherein the program instructions are executable by computer hardware to cause the computer hardware to initiate executable operations comprising:
emitting audible sound and ultrasound signals from a plurality of speakers of an electronic device;
detecting reflected ultrasound signals by a plurality of microphones of the electronic device;
detecting, based on the reflected ultrasound signals, presence of a user of the electronic device; and
in response to the detecting the presence of the user, adjusting audio played through one or more of the plurality of speakers as audible sound.

16. The computer program product of claim 15, wherein the detecting presence comprises:
calculating cross-correlation values between the ultrasound signals and the reflected ultrasound signals.

17. The computer program product of claim 16, wherein the program instructions are executable by computer hardware to cause the computer hardware to initiate executable operations comprising:
detecting a position of the user relative to the electronic device based on the cross-correlation values.

18. The computer program product of claim 17, wherein the adjusting comprises steering audio of one or more audio channels to at least one speaker of the plurality of speakers based on the position of the user.

19. The computer program product of claim 17, wherein the program instructions are executable by computer hardware to cause the computer hardware to initiate executable operations comprising:
generating distribution coefficients from the cross-correlation values;
generating gain masks from the distribution coefficients; and
processing the audio of each speaker using the gain masks.

20. The computer program product of claim 19, wherein the gain masks adjust an amount of audio corresponding to each channel played through one or more of the plurality of speakers.
